(19) United States
(12) Patent Application Publication
(10) Pub. No.: US 2004/0177786 A1
(43) Pub. Date: Sep. 16, 2004

(54) Scented paint and surface protectant

(76) Inventors: Leo Roy Durocher, Orlando, FL (US); Joseph Thomas Hesseling, Orlando, FL (US)

Correspondence Address: LEO R. DUROCHER, 111 N. JAMES AVE, ORLANDO, FL, 32801, US

(21) Appl. No.: 10/401,396

(22) Filed: Mar. 14, 2003

(51) Int. Cl. C09G 1/00

(52) U.S. Cl. 106/3; 106/4; 106/5; 106/6; 106/7; 106/8; 106/9; 106/10; 106/11; 106/270; 106/271; 106/272; 431/288

(57) ABSTRACT

A wax or polish also known as a surface protectant where ones primary reason for applying it is to impart a long lasting and specific scent or fragrance to a surface, such as that of an automobile, or any other surface of choice. As a secondary consideration the product will also offer surface protection from the elements. The product may be if so desired, colored to match the generally accepted color of that specific scent

### BACKGROUND OF THE INVENTION

There are many known waxes or polishes, both synthetic and natural or a combination of both, all having different formulas and all offer varying degrees of surface protection. Our protectant does not try to improve on their current formulas for surface protection, but adds another very desirable and novel component to waxing or polishing of a vehicle or other surface-a strong fragrance. The current waxes, polishes, or surface protection products usually have an odor which is a result of their base components and sometimes can be objectionable. Some products do add a small amount of fragrance but it is only designed to give their products a less objectionable or more neutral odor. The primary focus of their products is surface protection. On the other hand the primary focus of our invention is to have a surface protectant that is chosen primarily because of its fragrance or scent. Waxing of a large surface such as an automobile is difficult and time-consuming, so the addition of scents to the surface protectant would be an extra incentive for people to wax or polish their vehicle, and in many cases would be the primary and only reason for applying the surface protectant.

Examples of the most closely related known, but different protectants are described in the following documents:

| Patent number | | |
|---|---|---|
| (U.S. unless stated otherwise) | Inventor | Issue date |
| 4,218,250 | Kasprzak | Aug. 19, 1980 |
| 4,284,668 | Nixon | Aug. 18, 1981 |
| 4,347,333 | Lohr, et al. | Aug. 31, 1982 |
| 4,592,934 | Wolstoncroft | Jun. 3, 1986 |
| 5,174,813 | Cifuentes, et al. | Dec. 29, 1992 |
| 5,288,314 | Howard, et al. | Feb. 22, 1994 |
| 5,330,787 | Berlin, et al. | Jul. 19, 1994 |
| 5,700,312 | Fausnight, et al. | Dec. 23, 1997 |
| 6,013,323 | Klayder, et al. | Jan. 11, 2000 |

### SUMMARY OF THE INVENTION

Objects of patentable novelty and utility taught by this invention is to provide a surface protectant which: is scented with any of a number of fragrances including, but not limited to, Apple, blueberry, berry, cherry,grape, green apple, lemon, liqorice, orange, peppermint, pine, pineapple, pina colada, spearnint, spice, strawberry, water melon, and many more scents or fragrances including those of popular Colognes.

The scented protectant could come in either paste, liquid, or spray form, and can also, if so desired, be colored to match a particular scent. The novelty of this invention is that waxing of a painted surface such as an automobile finish is time-consuming and tiring and adding the dimension of a desirable long lasting scent would certainly increase the reasons for waxing or polishing. In fact the novelty of having one's automobiles exterior scented, would in many cases be the primary and only reason for someone to apply a protectant. The fragrance of the protectant chosen could coincide with the color of the surface. For instance, a red car could be waxed with a strawberry or cherry scent, a blue car could be waxed with a blueberry scent, and a black car could be waxed with a liqorice scent. Any additional reason for a person to put forth the extra labor to apply protectant to the painted surface of their vehicle or other valuable property, is certainly of value, and will also help to maintain the value of that property.

### DESCRIPTION OF PREFERRED EMBODIMENT

A scented protectant also known as wax or polish could use commercially available wax or polish bases whether natural or synthetic, in an oil or water base, in a paste, liquid, or spray form. The scent or fragrance may be synthetic or natural and be oil or water based, depending on the formula on the protectant base. The product can also be colored to coincide with the generally accepted colors for that particular scent.

A new and useful scented paint and surface protectant having been described, all such foreseeable modifications, adaptations, substitution of equivalence, possible combinations, pluralities of parts, applications and forms thereof and describe by the following claims and not precluded by prior art, are included in this intention.

What is claimed is:

1. A wax or polish that has a scent or fragrance:

2. The wax or polish of claim 1, wherein the scent includes apple;

3. The wax or polish of claim 1, wherein the scent includes blueberry;

4. The wax or polish of claim 1, wherein the scent includes berry;

5. The wax or polish of claim 1, wherein the scent includes cherry;

6. The wax or polish of claim 1, wherein the scent includes grape;

7. The wax or polish of claim 1, wherein the scent includes green apple;

8. The wax or polish of claim 1, wherein the scent includes lemon;

9. The wax or polish of claim 1, wherein the scent includes liqorice;

10. The wax or polish of claim 1, wherein the scent includes orange;

11. The wax or polish of claim 1, wherein the scent includes peppermint;

12. The wax or polish of claim 1, wherein the scent includes pine;

13. The wax or polish of claim 1, wherein the scent includes pineapple;

14. The wax or polish of claim 1, wherein the scent includes pina colada;

15. The wax or polish of claim 1, wherein the scent includes spearmint,

16. The wax or polish of claim 1, wherein the scent includes spice;

17. The wax or polish of claim 1, wherein the scent includes strawberry;

18. The wax or polish of claim 1, wherein the scent include watermelon;

19. The wax or polish of claim 1, wherein the scent includes Cologne;

19. A wax or polish that has a scent or fragrance and a coloring:

20. That coloring of claim 19, being consistent throughout the mixture;

21. That coloring of claim 19, being used in a design which is on or throughout the mixture;

22. That coloring of claim 19, being inconsistent or random throughout the mixture;
